(19) United States
(12) Patent Application Publication
(10) Pub. No.: US 2023/0230711 A1
(43) Pub. Date: Jul. 20, 2023

(54) LIGHT-WATER NUCLEAR REACTOR (LWR), IN PARTICULAR A PRESSURISED WATER REACTOR (PWR) OR BOILING WATER REACTOR (BWR), INCORPORATING AN INTEGRAL, AUTONOMOUS, PASSIVE DECAY HEAT REMOVAL SYSTEM

(71) Applicant: COMMISSARIAT A L'ENERGIE ATOMIQUE ET AUX ENERGIES ALTERNATIVES, Paris (FR)

(72) Inventors: Guillaume LHERMET, Grenoble Cedex 09 (FR); Nadia CANEY, Grenoble Cedex 09 (FR); Franck MORIN, Saint Paul Lez Durance (FR); Nicolas TAUVERON, Grenoble Cedex 09 (FR)

(73) Assignee: COMMISSARIAT A L'ENERGIE ATOMIQUE ET AUX ENERGIES ALTERNATIVES, Paris (FR)

(21) Appl. No.: 18/156,549

(22) Filed: Jan. 19, 2023

(30) Foreign Application Priority Data
Jan. 19, 2022 (FR) 22 00434

(51) Int. Cl. G21C 1/32; G21C 15/253

(52) U.S. Cl. CPC G21C 1/322; G21C 15/253

(57) ABSTRACT

An organic Rankine cycle machine and a supplementary reservoir of water, distinct from the pool, the energy stored in the pool being the hot source for the organic Rankine cycle evaporator, the supplementary reservoir of water feeding the organic Rankine cycle condenser directly via a dedicated pump to constitute the cold source of the organic Rankine cycle condenser.

### TECHNICAL FIELD

The present invention concerns the field of nuclear reactors, in particular pressurised water and boiling water nuclear reactors.

To be more specific, the invention relates to improving the decay heat removal function of these nuclear reactors in an accident situation. It aims to integrate a passive and autonomous decay heat removal system in the architecture of advanced light-water reactors (LWR) safety systems.

An objective of the invention is therefore to alleviate a major disadvantage of prior art safety passive condensers or passive wall condensers that resides in the necessity for volumes of water at very great height, which burdens and complicates the civil engineering for a nuclear installation, which is a severe constraint, in particular with regard to the earthquake problem, and increases the cost.

The second advantage of the invention consists in obtaining better overall performance of this type of system because of passive cooling using natural convection and an exchanger that is more compact because of improved heat exchange performance, and therefore obtaining a smaller overall volume of the system.

It must be remembered that the decay heat of a nuclear reactor is the heat produced by the core after the nuclear chain reaction is stopped and consisting of the disintegration energy of the fission products.

Although described with reference to a pressurised water reactor, the invention applies to a boiling water nuclear reactor or any light-water nuclear reactor (LWR) the safety decay heat evacuation means, as envisaged at present, necessitate providing large quantities of water at height as a cold source.

### PRIOR ART

A pressurised water reactor (PWR) comprises three cycles (fluidic circuits) the general principle of which in normal operation is as follows.

The pressurised water in a primary circuit takes up the energy supplied in the form of heat by the fission in the core of the reactor of uranium nuclei, and plutonium nuclei where applicable.

This pressurised water at high temperature, typically at 155 bar and 300° C., then enters a steam generator and transmits its energy to a secondary circuit, that circuit also using pressurised water as a heat-exchange fluid. This water in the form of steam at high pressure, typically approximately 70 bar, is then expanded via an expansion member transforming the variation of enthalpy of the fluid into mechanical and then electrical work in the presence of an electrical generator.

The water in the secondary circuit is then condensed via a condenser utilising a third cycle, the cooling cycling, as cold source.

Unlike a pressurised water reactor, a boiling water reactor (BWR) has no steam generator: it comprises only one circuit for water and steam produced after evaporation in the containment vessel. The water in the primary circuit is partially vapourised in the core. This water circulates under pressure but at a pressure less than that of a pressurised water reactor, typically 70 to 80 bar.

FIG. 2 of publication [1] illustrates the general configuration of a boiling water reactor. The water extracted from the condenser is pumped at the pressure of the reactor containment vessel via main pumps and admitted into the containment vessel at the periphery of the core. It is then mixed with and heated by a high flow of saturated water resulting from the separation of the steam-water emulsion produced in the core. On leaving the core the water-steam mixture is separated by gravity and by centrifuging. The steam produced is directed to downstream steam collectors and turbines, and for its part the saturated water is recirculated to be mixed with colder water. The water mixture descends the wall of the containment vessel, where it is taken up via primary loops external to the containment vessel by primary pumps to be directed into the core, and then passes through the core where the heat produced is extracted, causing heating to the point of saturation and evaporation.

A boiling water reactor comprises safety condensers also known as isolation condensers: they constitute the final recourse for emergency cooling of the reactor core. A schematic illustration of the arrangement of an isolation condenser is given in FIG. 4 of publication [1].

However, although the operation of light-water reactors (LWR) is known, mastered and reliable, the history of nuclear energy, in particular the Fukushima-Daiichi accident in 2011, has shown up weaknesses in the management of power stations in extreme accident situations with long-term loss of power from the electrical grid, aggravated by loss of the internal electrical generation means and the cold source.

This accident situation arises in particular from defective decay heat removal from the reactors. These accident sequences were also encountered in the fuel cooling pools during the Fukushima-Daiichi accident in 2011.

The reactor core decay heat phenomenon is manifested in the following manner.

When the nuclear reaction is stopped, the fission products that are disintegrating continue to produce heat until a stable state is reached.

One second after shutting down the reactor this heat represents 7% of the nominal thermal power of the reactor.

It then decreases over time as represented in FIG. 1 in publication [2].

For example, 72 hours after shutting down the reactor it still represents 0.5% of the nominal thermal power. It is therefore of primordial importance to evacuate this heat to prevent all risk of deterioration or even of melting of the fuel in the core.

For example, the VVER TOI pressurised water reactor has a nominal electrical power of 1300 Mwe and nominal thermal power of approximately 3200 MWth. 72 hours after it is shut down this reactor is still producing a residual thermal power of approximately 20 MWth.

Generally speaking, for the evacuation of the decay heat there is constantly being sought an improvement in the passivity and the diversification of the systems to guarantee better overall reliability. The objective is to preserve the integrity of the structures, namely the first containment barrier (fuel assembly sheath), second containment barrier (primary circuit) and third barrier (containment vessel), and this even in the case of a long-term generalised lack of electrical power, which is a Fukushima-type scenario.

To be more specific, since the Fukushima-Daiichi accident a great deal of research has been focused on passive decay heat evacuation technologies over time periods of several tens of hours.

The requirements for the new solutions depend above all else on improving performance and their reliability, as well as the greatest possible autonomy of operation, meaning at least 72 hours, before any human intervention and use of external hardware means.

More critically, in the context of the invention, an accident situation is considered with long-term (typically several days) interruption of power supplies from any source, apart from battery power. A situation of this kind is known as a Station Blackout (SBO).

One of the effective means for extraction of decay heat from the core of a pressurised water reactor in an accident situation without active means necessitating electricity is to cool the core of the reactor via a passive system by directing its heat energy either to the atmosphere via an air exchanger or to a water reservoir (pool) located at height, in order to procure natural convection. A system of this kind is known as a passive residual heat removal (PRHR) system.

A passive residual heat removal system has the same overall structure, whether that is for cooling by air or by water: a cooling circuit is arranged at the exit of the steam generator of the pressurised water reactor. Accordingly, instead of directing steam from the secondary circuit into the turbine, the steam is sent into a parallel circuit where it is cooled and condensed either by an air condenser or by a water condenser.

A first natural circulation loop enables transfer of heat energy from the core to the steam generator, followed by a second loop from the steam generator to a condenser. Thus the evacuation of the residual heat emitted by the core of the reactor is obtained by way of the steam generator and two natural circulation loops that are therefore passive.

An example of an air condenser for passive residual heat removal already in use is that of the VVER TOI pressurised water reactor the thermal and electrical powers of which are referred to hereinabove: the air condenser is in the form of a monotube exchanger with circular fins in a serpentine overall conformation.

The advantages of an air condenser, like this one, reside in the fact that air is an inexhaustible cold source (in an open medium) and naturally present. This air condenser technology is therefore totally independent of the cooling time and there is no phenomenon of progressive loss of cold source.

The major disadvantage of this technology is the volume of air exchangers. In fact, the coefficients of thermal exchange with air being low, the volumes and the areas necessary for air exchangers are very large and thermal extraction performance is very dependent on meteorological conditions.

For example, the VVER TOI passive residual heat removal system is sized to be able to extract residual heat equal to 2% of the nominal thermal power of the reactor, i.e. a power of 64 MWth. To achieve this kind of power it has been necessary to install 16 units with an exchange area equivalent to several thousand square metres, situated in the upper part of the nuclear installation.

As mentioned hereinabove, the decay heat evacuation necessary to cool the core of a pressurised water reactor may be produced by a water condenser, as illustrated schematically in FIG. 2. The reactor core 1 is connected to a steam generator 2 and decay heat removal is provided by a passive natural circulation closed loop 3 that includes the steam generator leading to a water condenser 4 submerged in a water reservoir or pool 5 placed at height. This loop 3 therefore makes it possible to transmit heat energy from the steam generator to the water reservoir 5. During decay heat removal this reservoir 5 rises in temperature up to the boiling point of water. The water evaporates into the air at atmospheric pressure with a certain kinetic.

Many current projects use water as the cold source for passive residual heat removal, among which there may in particular be cited:
the AP-600 and AP-1000 project of the American company Westinghouse;
the Hualong-1 project of the Chinese companies China General Nuclear Power Corporation (CGNPC) and Chinese National Nuclear Company (CNNC);
the VVER1200 project of the Russian company ROSATOM, in the version using passive safety condensers employing water as the cold source.

This decay heat removal system has major disadvantages.

Firstly, the presence of a water source at height complicates and burdens the civil engineering because of the need for this safety cold source to keep an intact structure in the case of extreme aggression of earthquake or aircraft collision type.

Moreover, because of the effect of the evaporation of water, the cooling time for the steam generator is directly linked to the volume of the pool: the greater the volume of water, the longer the cooling time. For example, the HPR1000 reactor with a nominal thermal power of 3060 MW includes a passive residual heat removal system the dimensions of which were designed to provide cooling for 72 hours, which implies a pool volume of 2300 m³:[3].

The problem with this system therefore resides in a necessary compromise between the pool civil engineering constraints and the cooling time achieved, typically 72 hours minimum.

Exactly the same problem arises for decay heat removal from a boiling water reactor (BWR), which has in particular led to the melting of the core of several sections of the Fukushima-Daiichi power station. In this case, it is no longer the steam from the secondary circuit of a steam generator but the steam coming directly from the reactor containment vessel which must then be cooled and condensed to evacuate the decay heat from the core. The cold source necessary for condensation and cooling of the primary steam must also be at height relative to the reactor core and of high volume. The dimensions of this cold source in the boiling water reactors involved in the Fukushima catastrophe did not make it possible to achieve passive operation for 72 hours, as is mostly required at present.

According to the accident protocols in place, it may equally be the containment vessel cooling and depressurisation system of the pressurised water or boiling water reactor that will then serve as decay heat removal means, in particular in the case of a primary circuit whether opened intentionally (so-called “boosted open” configuration in the ultimate scenario) or not (situation of loss of primary coolant following a primary breach-type accident). The ultimate cold source is then dedicated to evacuation of the of decay heat associated with this kind of cooling means.

In the two situations cited above, these two types of passive safety condenser are able to function over a long period only on condition that a water cold source of sufficient quantity enables collection of the necessary thermal power to cool the reactor core.

As in the application concerning pressurised water reactors, this cold source must be located at height relative to the assembly formed by the containment vessel of the reactor and its containment enclosure, in order to establish natural circulation enabling evacuation of thermal power from the core of the reactor or the centre of the containment enclosure.

Generally speaking, natural circulation of a monophase or diphase fluid is possible provided that the cold source increasing the density of the fluid is located at a greater height than the hot source reducing the density of that same fluid. In the contrary situation thermal stratification and blocking of the natural circuit occur.

Thus an autonomous cold source supply device would make it possible considerably to extend the autonomy of operation of this type of safety system compared to operation of a few hours because of constraints of restriction of the volume of water at height.

By way of illustration, FIG. 2 of publication [4] gives an idea of the necessary volumes of cold source at height dedicated to the operation of the passive containment cooling system (PCCS) dedicated on the one hand to ultimate evacuation and to the isolation condenser dedicated on the other hand to safety evacuation.

The use in an accident situation of an organic Rankine cycle (ORC) machine in addition to a cooling system of a pressurised water reactor (PWR) has already been envisaged.

As explained above, the problem of passive residual heat removal using water resides in the relation between the volume of the pool and the cooling time.

Also, one solution to this problem consists in removing some of the energy accumulated in the pool via an exchanger. This exchanger is then used as an evaporator of the organic Rankine cycle. The condenser of the organic Rankine cycle is an air condenser (aerocondenser).

This solution enables the use of the power produced by the turbine of the organic Rankine cycle by the turbine-generator coupling to supply the pump of the organic Rankine cycle, which results in an autonomous system enabling evacuation of some of the heat stored in the pool.

An organic Rankine cycle of this kind therefore makes it possible to recover some of the energy stored in the form of heat in the pool and to evacuate/monetise it in a dedicated circuit and thus to limit the quantity of water evaporated from the pool and therefore to lengthen the time of cooling by the pool.

Accordingly, the patent application WO2012/145406 has proposed a solution of this kind but for a different application field. In fact, the heat energy fed into the pool comes from spent nuclear fuels still producing heat. This technology applied to a pressurised water reactor can therefore palliate some of the problems referred to above. In fact, some of the heat energy stored in the pool can be removed by an organic Rankine cycle circuit, which makes it possible to increase the core decay heat removal time for a given pool volume.

However, although enabling improvement of the ratio between the cooling time and the volume of the pool, the efficacy of this technology is dependent on the volume of the exchangers enabling evacuation of the heat to the ultimate cold source (air). In fact, for this system to be really functional throughout the period of cooling a light-water reactor, the power extracted by the exchanger of the pool cooling cycle would have to be of the same order of magnitude as the power exchanged between the pool and the reactor.

Now, as explained above, in the case of the VVER TOI reactor the decay heat of the reactor is of the order of several tens of MW.

Accordingly, employing an organic Rankine cycle as proposed in the aforementioned application, removing all, or at least a very large part, of the power exchanged between the pool and the reactor would need colossal installation volumes, especially for the final air exchanger.

In other words, although enabling extraction of decay heat from the core of the reactor for a longer given time than in an organic Rankine cycle, the system proposed in the patent application WO2012/145406 remains of very limited real use and really effective for residual powers of hundreds of kW.

The patent application WO2013/019589 proposes a similar solution, namely cooling spent nuclear fuels by submerging them in a water reservoir and using the heat energy of that water reservoir to operate an organic Rankine cycle or a Stirling cycle. This patent application further proposes adding a thermoelectric module to use the heat produced by the spent fuels by transformation thereof into electricity.

The novelty of these solutions according to WO2013/019589 resides in the use of the electricity produced by these various systems, in addition to the heat energy extracted from the pool, employing two water pumps, one of which directs water from the reservoir (pool) at the level of a ventilator, placed at height, to cool it, and the other of which pumps water from another water reservoir to palliate the evaporation of water from the pool.

Accordingly, thanks to these water pumps there is no longer a direct link between the cooling time and the pool volume since a dedicated pump enables constant feeding of water to the pool.

However, the solution according to WO2013/019589 has a number of disadvantages.

Firstly, the exchangers of the cold source of the Stirling cycle or of the organic Rankine cycle are air exchangers and, as explained above, these exchangers can be of very large volume and necessarily located at height.

Moreover, air exchangers have the characteristic of being greatly dependent on the outside temperature and therefore on its variability. To ensure their reliability it is therefore necessary for the system to be able to adapt to temperature variations in the geographical zone of the power station.

Thus there exists a need to improve decay heat removal systems of light-water nuclear reactors (LWR), in particular pressurised (PWR) or boiling water reactors (BWR), in order to palliate the aforementioned disadvantages using an organic Rankine cycle machine.

### STATEMENT OF INVENTION

To this end, in one of its aspects, the invention concerns a light-water nuclear reactor (LWR), in particular a pressurised water reactor (PWR) or a boiling water reactor (BWR), including:
a reactor core;
a system for evacuation of at least some of the decay heat from the reactor core, the system including:

a first reservoir of water or pool arranged above the reactor core; a heat exchange means submerged in the pool so that the water contained in the latter cools the steam coming from a steam intake means of the primary or secondary circuit of the reactor;

an organic Rankine cycle machine including:
an expander;
a condenser;
a first pump;
an evaporator arranged in contact with the pool so that the latter constitutes the hot source of the organic Rankine cycle;
a fluidic circuit in which a working fluid circulates in a closed loop, the fluidic circuit connecting the expander to the condenser, the condenser to the first pump, the first pump to the evaporator, and the evaporator to the expander;

a second reservoir of water, distinct from the pool, and a second pump connected to the second reservoir of water and to the organic Rankine cycle condenser to feed the latter with water as the cold source of the organic Rankine cycle.

For a pressurised water nuclear reactor (PWR) in accordance with a first embodiment, the reactor (PWR) includes a cooling circuit including a steam generator and a water condenser submerged in the pool and connected to the steam generator in a closed loop.

For a pressurised water nuclear reactor (PWR) in accordance with a second embodiment, the decay heat removal means present in the primary circuit is a liquid/liquid exchanger and the heat exchange means is a water exchanger submerged in the pool so that the water contained in the latter cools the water of the primary circuit circulating in the liquid/liquid exchanger.

For a boiling water nuclear reactor (BWR) in accordance with a first embodiment, the reactor (BWR) includes a cooling circuit including:
an intake of primary steam on the line feeding the turbine of the reactor;
a water condenser submerged in the pool and connected to the steam intake in a closed loop.

For a pressurised water reactor (PWR) or a boiling water reactor (BWR) in accordance with another embodiment, the means for removing decay heat from the core of the reactor may be a system for depressurisation of the steam present in the containment enclosure and the heat exchange means may be a water exchanger submerged in the pool or a direct intake of water from the pool, on the one hand, and a containment wall condenser in direct contact with the steam present in the containment vessel of the reactor, on the other hand.

The second reservoir of water is advantageously arranged in a part lower than the pool, advantageously on or in the ground.

The organic Rankine cycle evaporator may be submerged in or located remotely from the pool.

The submerged evaporator is preferably a tubular exchanger or a plate exchanger.

In accordance with an advantageous embodiment the reactor further includes a cooling cycle including:
a compressor;
a condenser connected to the second pump to feed the latter with water;
an expansion member;
an air evaporator;
a fluidic circuit in which a working fluid circulates in a closed loop, the fluidic circuit connecting the compressor to the condenser, the condenser to the expansion member, the expansion member to the air evaporator, and the air evaporator to the compressor.

The cooling cycle condenser is advantageously the organic Rankine cycle condenser.

The working fluid of the cooling cycle is more advantageously that of the organic Rankine cycle.

In accordance an advantageous variant, the shaft of the organic Rankine cycle expander is coupled to the shaft of the cooling cycle compressor.

In accordance with another advantageous variant, the organic Rankine cycle machine and where applicable the cooling cycle is (are) arranged in a lower part of the system, below the pool.

In accordance with a further variant, the reactor may include an injector arranged in a lower part of the system and connected to the second pump arranged in a higher part of the system, the injector being adapted to prime the second pump.

The reactor preferably includes batteries for electrically starting the first pump, electric components of the organic Rankine cycle and where applicable of the cooling cycle, as well as the second pump.

Thus the invention employs firstly a safety passive condenser system using as cold source a reservoir of water or pool in which the passive condenser is submerged and that is located at height (above the reactor core). This pool enables decay heat removal from the core of the reactor.

Now, as explained in the preamble, this architecture is dependent on the volume of the pool: the cooling time of the pool is proportional (or linked directly) to its volume and is therefore limited.

To palliate this the invention essentially consists in implanting an organic Rankine cycle machine and a supplementary reservoir of water, separate from the pool, the energy stored in the pool being the hot source for the evaporator of the organic Rankine cycle, the supplementary reservoir of water directly feeding the condenser of the organic Rankine cycle via a dedicated pump to constitute the cold source for the condenser of the organic Rankine cycle.

Thus the losses of water by evaporation from the pool are compensated by feeding water from the supplementary reservoir, advantageously in a lower part, preferably at ground level, compared to the pool in the high part.

A major advantage of arranging the cold source on the ground is the very great simplification of the civil engineering dedicated to supporting and protecting this safety cold source volume in the upper part of the nuclear installation and the reduction of construction and maintenance costs and the cost of the resulting earthquake resistance studies.

The decay heat removal system according to the invention differs from the prior art systems in particular in the following aspects:
in contrast to existing systems that use air as the cold source, the water conducted from the lower part of the supplementary reservoir of water serves as a cold source for the organic Rankine cycle condenser,
this water supplied from the supplementary reservoir of water can advantageously also serve as the cold source for the condenser of a cooling cycle the objective of which is to produce cold power, for example, to cool the expander of the organic Rankine cycle and therefore to assure greater autonomy and reliability of the system.

A major advantage of a system configuration according to the invention, compared to the geometries of existing systems, is therefore the use of water fed at height to feed the pool experiencing evaporation, as cold source for the condenser of the organic Rankine cycle and advantageously of a cooling cycle.

Accordingly, a configuration of a system according to the invention enables the use of a plate-type water exchanger as the evaporator of the organic Rankine cycle, which must undoubtedly be located remotely from the pool but the volume of which is much smaller than equivalent power air condensers. By way of illustrative example, a plate water exchanger has a convection exchange coefficient improved by a factor of 50 to 100 relative to a condenser the fluid of which is air.

The use of a water exchanger enables reduction of the condensation pressure of the organic Rankine cycle fluid in the organic Rankine cycle and therefore efficiency is increased.

Using pumped water as the cold source of the organic Rankine cycle and advantageously of the combined cooling cycle further makes possible a great increase in the reliability of the system: the reduction of the volumes of the exchangers makes them less vulnerable to external aggression, whether natural or malevolent.

Moreover, water/water plate condensers are exchangers very well known in the art, having great reliability (an essential criterion in the nuclear field).

Accordingly, the fact that the cold source of the exchangers of the cold source (reactor cooling cycle, organic Rankine cycle, cooling cycle) is water avoids the use of a complementary cold source, which is air in the prior art.

As explained above, an air exchanger is extremely dependent on the ambient air temperature. Accordingly, using water from a reservoir in the lower part of the installation as the cold source of the organic Rankine cycle makes it possible to be less dependent on the outside temperature and therefore its variations.

In fact, with the invention, there is no longer any power limitation because of the cold source of the cycle. In fact, the size of the water exchanger and the temperature conditions on the cold source side are not as limiting as with a prior art air condenser, where the aim is to minimise its size, without mentioning the temperature of the air referred to above.

The invention therefore makes it possible to produce high electrical power and therefore the possibility of conducting large quantities of water from the low part to the high part with small installation volumes.

Adding a cooling cycle to the organic Rankine cycle according to the invention makes it possible to cool the expander of the organic Rankine cycle as well as other components, for example of the power electronics, to be cooled and therefore to increase the autonomy and the reliability of the system. A single condenser can advantageously be shared by the organic Rankine cycle and the cooling cycle, which is possible with working through flows that are fluidically either in series or in parallel.

The surplus electricity from the organic Rankine cycle in accordance with the invention can cover not only the needs described above but also other safety electrical needs of the installation, such as the supply of electrical power of control, measurement, cooling, etc. devices.

The system according to the invention implies the use of batteries necessary for starting the system. In fact, the cold source of the organic Rankine cycle being water from the supplementary reservoir, it is necessary to start the water pump that will take water in from the supplementary reservoir to start the system. The energy accumulated in these batteries may be very limited, and redundant multiple groups enable great reliability to be achieved.

In the final analysis, a nuclear reactor with a system according to the invention has numerous advantages, among which there may be cited:
significant improvement of the existing cooling system of a nuclear reactor, in particular that of a pressurised water reactor including a steam generator, a natural convection closed loop circuit and a cooling pool;
reliable and autonomous system;
possibility of having a nuclear installation with small volumes in the upper part, which lightens the civil engineering and cost constraints;
maintaining the passive design of decay heat removal from the reactor by using a passive condenser and the cold source at height. Decay heat removal continues to be driven by the progressive evaporation from the cold source and does not rely entirely on an active system such as an organic Rankine cycle circuit. Only the cold source autonomy depends on the operation of this active but autonomous system. Thus there is no loss of reliability of the decay heat removal function, as in the hypothesis where all the decay heat would have to relay one an active circuit of organic Rankine cycle type: [5].

Other advantages and features of the invention will emerge more clearly on reading the detailed description with reference to the appended figures of embodiments of the invention provided by way of illustrative and non-limiting illustration only.

### BRIEF DESCRIPTION OF THE DRAWINGS

FIG. 1 illustrates in the form of a curve the decrease over time of the decay heat of a prior art nuclear reactor known as a VVER TOI reactor.

FIG. 2 is a schematic view of a passive decay heat removal system for a prior art pressurised water reactor-type nuclear reactor core.

FIG. 3 is a schematic view of a passive system for decay heat removal from a pressurised water reactor-type reactor core according to one embodiment of the invention.

FIG. 4 is a T-s entropy diagram of the organic Rankine cycle and of the cooling cycle of a system like that in FIG. 3.

FIG. 5 is a schematic view illustrating a first variant of a system according to the invention.

FIG. 6 is a schematic view illustrating a second variant of a system according to the invention.

FIG. 7 is a schematic view illustrating a third variant of a system according to the invention.

FIG. 8 is a schematic view illustrating another embodiment of the invention with a system for depressurisation of the steam present in the containment vessel of a boiling water or pressurised water reactor.

FIG. 9 is a schematic view illustrating a first variant of a heat exchange means according to the invention for a boiling water or pressurised water reactor.

FIG. 10 is a schematic view illustrating a first variant of a heat exchange means according to the invention for a boiling water or pressurised water reactor.

### DETAILED DESCRIPTION

Throughout the present application the terms “vertical”, “lower”, “upper”, “low”, “high”, “under” and “over” are to be understood with reference to a cooling pool of a nuclear reactor filled with water, as it is in a horizontal operating configuration, arranged above the reactor core.

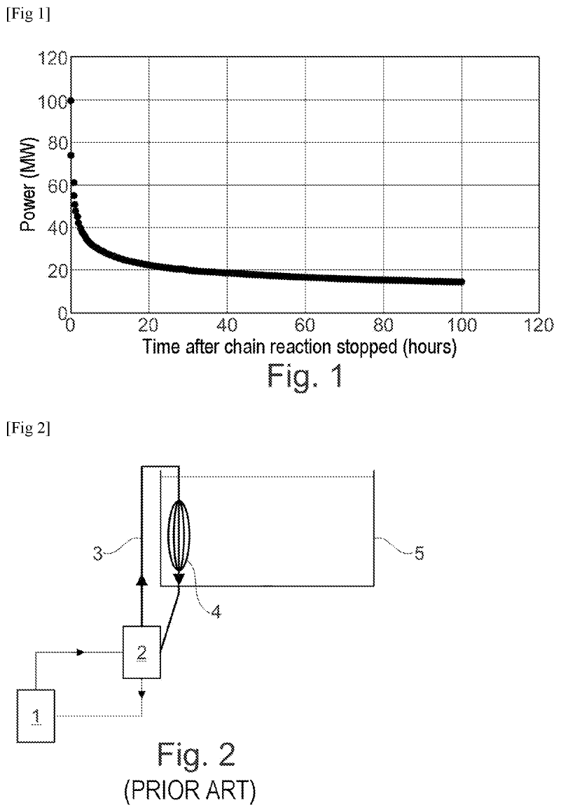

FIGS. 1 and 2 have already been described in the preamble and will therefore not be commented on hereinafter.

Elements common to the invention and to the prior art are designated by the same reference number in all of FIGS. 1 to 10.

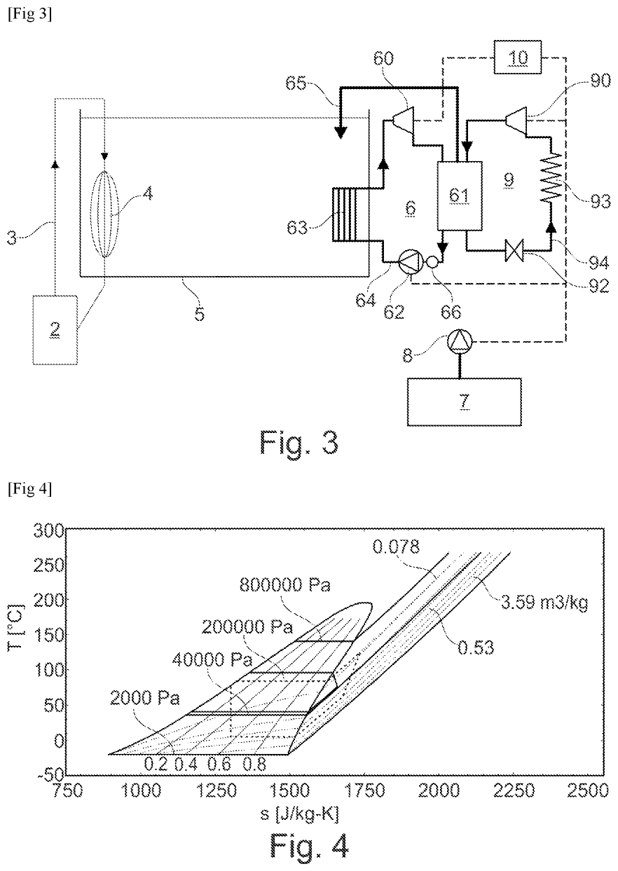

In FIGS. 3 to 7 relating to the invention only a part of the system for cooling a pressurised water nuclear reactor core is represented, namely the steam generator connected in a closed loop to a water exchanger submerged in the cooling pool.

The dashed lines denote electrical power lines of the various electrical components while solid lines denote fluid lines.

There has been illustrated in FIG. 3 an autonomous system according to the invention for evacuation of at least some decay heat from a pressurised water reactor.

The system includes firstly the cooling pool 5 arranged above the reactor core and a water condenser 4 submerged in the pool so that the water contained in the latter cools the steam issuing from the secondary circuit of the reactor.

It also includes an organic Rankine cycle (ORC) machine 6 including:
an expander 60;
a condenser 61;
a first pump 62, for a working fluid;
an evaporator 63 arranged relative to the pool 5 so that the latter constitutes the hot source of the organic Rankine cycle;
a fluidic circuit 64 in which a working fluid circulates in a closed loop.

As illustrated, and according to the invention, the fluidic circuit 64 connects the expander 60 to the condenser 61, the condenser 61 to the first pump, termed the pump 62 of the organic Rankine cycle, the pump 62 of the organic Rankine cycle to the evaporator 63, and the evaporator 63 to the expander 60.

A second reservoir of water forming a general pool 7 contains all of the cold source dedicated to cooling the reactor and feeds the pool 5 dedicated to the organic Rankine cycle and containing the safety condenser 4 and the organic Rankine cycle evaporator 63.

The water from the pool 7 serves as a cold source for the exchanger condenser 61. The water from the pool 7 is slightly heated by the condenser 60 before being injected into the pool 5 by means of a second pump, which is a water supply pump 8. This pump 8 feeds a dedicated fluidic line 65 to palliate the evaporation of the pool 5 receiving the reactor decay heat.

The expander 60 may typically be a turbine, a spiral, screw, piston, etc. pressure regulator.

The condenser 61 is typically a plate condenser.

The organic Rankin cycle pump 62 is typically a centrifugal, or membrane, screw, etc. pump.

The machine 6 may include a surge tank 66, that is to say a reserve of a quantity of working fluid enabling in particular adequate functioning of the organic Rankine cycle under varying conditions. As illustrated in FIG. 3, this surge tank 66 can be arranged upstream of the organic Rankine cycle pump 62.

In the embodiment illustrated in FIG. 3 the evaporator 63 is a tubular evaporator submerged vertically in the pool 5.

The system also includes a second reservoir 7 of water, distinct from the pool, and a water pump 8 connected to the second water reservoir and to the condenser 61 of the organic Rankine cycle to supply the latter with water, as the cold source of the organic Rankine cycle.

In the advantageous embodiment from FIG. 3 there is further provided a cooling cycle 9 including:
a compressor 90;
a condenser 61, which is that of the organic Rankine cycle, connected to the water pump 8, to supply the latter with water;
an expansion member 92;
an air evaporator 93;
a fluidic circuit 94 in which a working fluid circulates in a closed loop.

The fluidic circuit 94 connects the compressor 90 to the organic Rankine cycle condenser 61, the condenser 61 to the expansion member 92, the expansion member to the air evaporator 93, and the air evaporator 93 to the compressor 90.

The expansion member 92 may be a valve or preferably a turbine, an ejector, etc.

Like the organic Rankine cycle 6, the cooling cycle 9 may also include a surge tank forming a reservoir of working fluid in this cycle.

Batteries 10 may be provided for electrically starting the various pumps 62, 8, the organic Rankine cycle electrical components, and where applicable the cooling cycle 9. To be more precise, the batteries may serve for the function of starting the organic Rankine cycle, that is to say starting the organic Rankine cycle pump 62 and activating the submerged pump 8 that feeds the cold source to the pool 5, thus making it possible to provide the cold source of the organic Rankine cycle (condenser exchanger).

An example of dimensions for an accident situation in the case of a pressurised water reactor with a power rating of 3200 MWth is given below.

The working fluid of the organic Rankine cycle is an organic fluid the evaporation temperature of which is lower than that of boiling water, approximately 100° C. at atmospheric pressure. There may in particular be cited Novec649, HFE7000, HFE7100, etc.

Numerous other organic fluids may be envisaged such as alkanes, HFC, HFO, HFCO, HFE, as well as other fluids (NH₃, CO₂) and all mixtures thereof.

The fluid used in the simulation of setting dimensions is HFE7100 and is advantageously used both in the organic Rankine cycle 6 and in the cooling cycle 9.

In this example temperature sensors or sensors of the level of water in the pool 5 enable detection of the complete saturation state of the pool 5 and the commencement of loss of liquid level by boiling off.

There is a delay for the pool 5 to be half-emptied before starting the filling pump 8. For reliability, the flowrate of the pump 8 is fixed at the flowrate of loss by evaporation from the pool, at the moment it is started.

Knowing that the residual power of the reactor core decreases with time, from the moment at which the pump 8 is started the pool 5 gains in water inventory.

Dimensions in relation to the pool are summarised in table 1 below.

TABLE 1

| Dimension | Value |
|---|---|
| Total volume of pool 5 | 1000 m³ |
| Height of pool 5 | 10 m |
| Height difference between pool 5 and water reservoir 7 | 50 m |

Information relating to the time for which the pool functions is summarised in table 2 below.

TABLE 2

| Functioning of pool | Duration (h) |
|---|---|
| Pool 5 becomes saturated | 1.5 |
| Pool 5 is half-empty/organic Rankine cycle 6 starts | 20 |
| Pool 5 refilled | 90 |

The flowrates are given in table 3 below:

TABLE 3

| Flowrate | Value (kg/s) |
|---|---|
| Flowrate of organic Rankine cycle working fluid | 1 |
| Flowrate of pumped water (cold source) | 6 |
| Flowrate of cooling cycle working fluid | 0.02 |

The outside temperatures are given in table 4 below:

TABLE 4

| Temperature | Value (° C.) |
|---|---|
| Mean temperature of the hot source | 100 |
| Temperature of the cold source | 30 |
| Temperature of the cold source (exit from cooling cycle) | 30 |
| Temperature of the cold source (exit from organic Rankine cycle) | 38 |

The internal pressures are given in table 5 below:

TABLE 5

| Pressure | Value (bar) |
|---|---|
| Organic Rankine cycle 6 high pressure | 2.7 |
| Organic Rankine cycle 6 low pressure | 0.5 |
| Cooling cycle 9 high pressure | 2.0 |
| Cooling cycle 9 low pressure | 0.1 |

The powers of the exchangers are given in table 6 below:

TABLE 6

| Power | Value (kW) |
|---|---|
| Organic Rankine cycle condenser (61) power | 170 |
| Organic Rankine cycle evaporator (63) power | 180 |
| Cooling condenser (61) power | 3 |
| Cooling evaporator (93) power | 2 |

The electrical powers are given in table 7 below:

TABLE 7

| Electrical power | Value (kW) |
|---|---|
| Organic Rankine cycle pump (62) | 0.5 |
| Water pump (8) | 7.5 |
| Compressor (90) | 0.7 |
| Electric turbine (60) | 8.6 |

Thus under all the above operating conditions the volume of the exchangers to be set dimensions is summarised in table 8 below:

TABLE 8

| Volume | Value (m³) |
|---|---|
| Organic Rankine cycle condenser volume | 0.01 |
| (HFE7100/Water) | |
| Cooling cycle condenser volume | 0.0005 |
| (HFE7100/Water) | |
| Organic Rankine cycle evaporator volume | 0.5 |
| (HFE7100/Water) | |

The T-s diagram of the organic Rankine cycle and the cooling cycle is shown in FIG. 4.

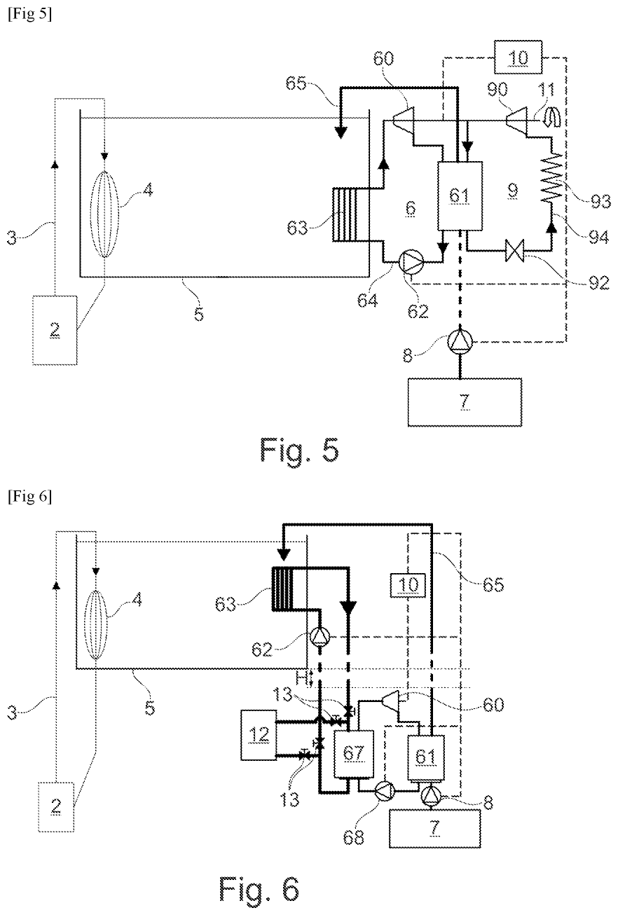

One possible variant of the FIG. 3 configuration consists in coupling the shaft 11 of the turbine 60 of the organic Rankine cycle 6 and the shaft of the compressor of the cooling cycle. This configuration shown in FIG. 5 makes it possible not to need to supply the compressor of the cooling cycle with electrical power and therefore saves energy (electromechanical conversions).

A second variant of the system consists in pooling the advantages of components between the organic Rankine cycle and the cooling cycle: the working fluid, some of the pipework, the condenser 61 as already illustrated.

Another variant of this system consists in placing the organic Rankine cycle and the cooling cycle in the lower part of the system, thanks to the presence of an intermediate circuit, which makes it possible to couple to the same shaft the organic Rankine cycle turbine and the pump 8 for feeding water from the lower part to the higher part. This enables improved reliability of the system, as in fact the transmission of power between the turbine and the water pump 8 is purely mechanical: there is no conversion of mechanical energy into electrical energy. However, this disposition obliges the organic Rankine cycle to be in the lower part, which renders it vulnerable to numerous accident situations: flooding, etc. Moreover, it is necessary to take heat energy from the pool in the lower part. This in particular also enables facilitated access for maintenance and surveillance by the operating personnel.

As shown in FIG. 6 it is also possible to place the organic Rankine cycle in the lower part, thanks to an intermediate circuit, without coupling the water pump 8 to the organic Rankine cycle turbine 60. This intermediate circuit then includes a supplementary evaporator 67 fed by means of a third pump 68. The advantage of this configuration will be the possibility of having the organic Rankine cycle function via an ancillary hot source 12 and valves 13 to enable maintenance/testing of the system to increase its reliability.

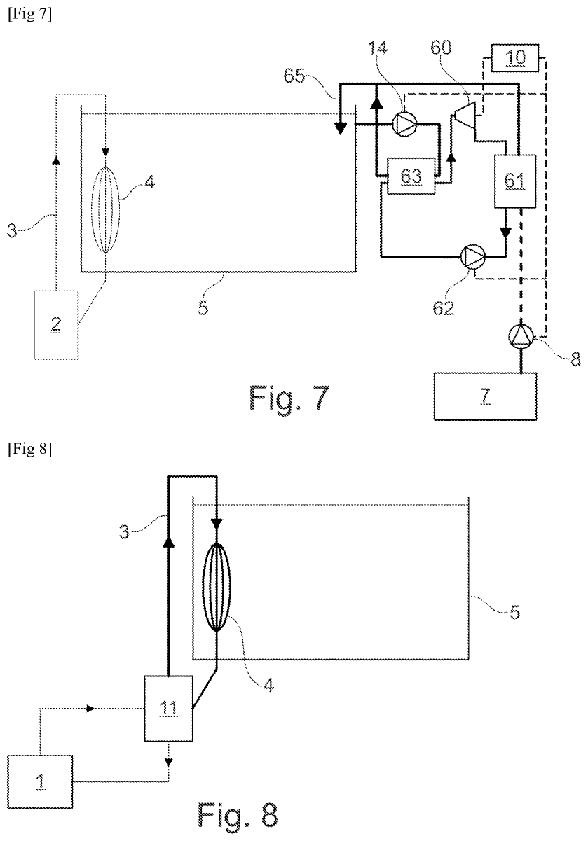

Another possible variant is not to use a submerged tubular evaporator as shown in FIG. 3 but a remotely located evaporator for example of plate type. To this end, it is necessary to feed the water from the reservoir in a pipe, via a pump 14 as shown in FIG. 7. This configuration enables reduction of the volume of the hot exchanger, reduction of the work of installing the exchanger over the pool or, as in the preceding configuration, the organic Rankine cycle functioning thanks to an ancillary hot source. It is to be noted that mixing water at the exit from the evaporator with that coming from the organic Rankine cycle condenser requires only a single intake from the pool instead of two in the other configurations and variants.

Another possible variant of this technology is to place a condensation injector in the lower part of the installation. It would thus be possible to position the water pump 8 in the upper part of the structure by actuating the pumping movement by means of the injector in the lower part. This configuration would make it possible to have the whole of the organic Rankine cycle and of the pump 8 in the upper part (and therefore safer from external aggression, flooding, etc.). This injector would enable priming of the system: being fed by a reserve of low-capacity thermal energy, this injector would direct into the intake pipe of the pump 8 a sufficient quantity of water to prime it.

The invention is not limited to the examples that have just been described; in particular features of the examples illustrated may be combined with one another in variants that are not illustrated.

Other variants and embodiments may be envisaged that do not depart from the scope of the invention.

The decay heat removal system that has just been described with reference to a pressurised water nuclear reactor may be used in a boiling water nuclear reactor (BWR).

Generally speaking, the invention applies to any pool 5 that can constitute the cold source intended to cool a pressurised water reactor core or a boiling water reactor core or to cool and/or depressurise the primary containment vessel of a pressurised water reactor or a boiling water reactor.

Accordingly, although in the examples illustrated the means for evacuation of decay heat from the core of the reactor include the steam generator, this means may equally well be a condenser installed in the containment vessel whether for a pressurised water reactor or for a boiling water reactor.

For example, for a pressurised water reactor reference may be had to the ambient condenser panels of the HPR1000 project (“Passive containment heat removal”) or to publication [6] which describes an optimised condenser mounted against the containment vessel wall (“Passive containment cooling system”). For a boiling water reactor see the configuration in the KERENA reactor of the containment cooling condensers.

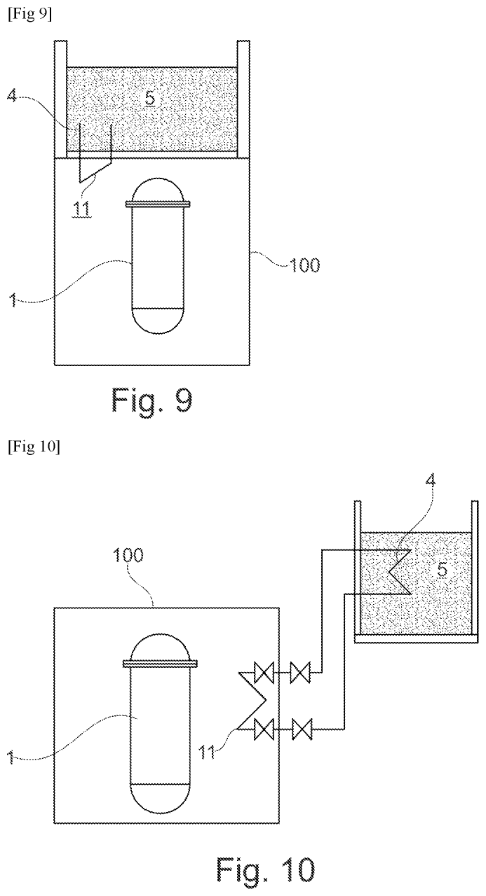

More generally, for a pressurised water reactor or a boiling water reactor the means for evacuation of decay heat from the core of the reactor may be a system for depressurisation of the steam present in the containment vessel (FIG. 8) and the heat exchange means may be a water exchanger 4 submerged in the pool 5 (closed loop configuration from FIG. 10, taken from reference [7]) or taking water directly from the pool 5 (closed loop configuration of FIG. 9, taken from reference [7]) on the one hand and of a containment wall condenser 11 in direct contact with the steam present in the containment vessel 100 of the reactor on the other hand.

The pool 5 may be a source feeding a sprinkler manifold of an enclosure sprinkler circuit which in an accident situation leading to a significant increase of pressure in the reactor building enables this pressure to be decreased and thus preserves the integrity of the containment vessel. For a pressurised water reactor see the configuration of internal sprinkler manifolds in the primary containment vessel of the HPR1000 project or external to the primary vessel of the AP1000 project.

### LIST OF CITED REFERENCES

[1]: https://www-pub.iaea.org/MTCD/Publications/PDF/TE-1785 web .pdf.
[2]: S. Kadalev et al, 2014, Annals of Nuclear Energy, vol. 72, p. 182-188.
[3]: D. C. Sun, Y. Li, Z. Xi, Y. F. Zan, P. Z. Li, W. B. Zhuo, “Experimental evaluation of safety performance of emergency passive residual heat removal system in HPR1000”, Nuclear Engineering and Design, Volume 318, 2017, Pages 54-60, ISSN 0029-5493, https://doi.org/10.1016/j.nucengdes.2017.04.003.
[4]: David Hinds and Chris Maslak, “Next-generation nuclear energy: The ESBWR” Nuclear News. January 2006.
[5]: Hofer, Buck, Starflinger, “Operational Analysis of a self-propelling Heat Removal System using supercritical CO2 with athlet”, The 4th European sCO2 Conference for Energy Systems Mar. 23-24, 2021, Online Conferences CO2, 2021-sCO2.eu-157.
[6]: Huiun Ha et al. “Optimal design of passive containment cooling system for innovative PWR” Nuclear Engineering and Technology 49 (2017) p. 941-952.
[7]: https://www-pub.iaea.org/MTCD/Publications/PDF/te_164_web.pdf

1. A light water nuclear reactor (LWR), comprising:
a reactor core;
a system for evacuation of at least some of the decay heat from the reactor core, the system including:
a first reservoir of water or pool arranged above the reactor core; a heat exchange device submerged in the pool so that the water contained in the latter cools the steam coming from a steam intake device of the primary or secondary circuit of the reactor;
an organic Rankine cycle (ORC) machine including:
an expander;
a condenser;
a first pump;
an evaporator arranged in contact with the pool so that the latter constitutes the hot source of the organic Rankine cycle;
a fluidic circuit wherein a working fluid circulates in a closed loop, the fluidic circuit connecting the expander to the condenser, the condenser to the first pump, the first pump to the evaporator, and the evaporator to the expander;
a second reservoir of water, distinct from the pool, and a second pump connected to the second reservoir of water and to the organic Rankine cycle condenser to feed the latter with water as the cold source of the organic Rankine cycle.

2. The water nuclear reactor according to claim 1, comprising a cooling circuit including a steam generator and a water condenser submerged in the pool and connected to the steam generator in a closed loop.

3. The water nuclear reactor according to claim 1, the decay heat removal device present in the primary circuit being a liquid/liquid exchanger and the heat exchange device being a water exchanger submerged in the pool so that the water contained in the latter cools the water of the primary circuit circulating in the liquid/liquid exchanger.

4. The water nuclear reactor according to claim 1, including comprising a cooling circuit including:
an intake of primary steam on the line feeding the turbine of the reactor;
a water condenser submerged in the pool and connected to the steam intake in a closed loop.

5. The water nuclear reactor according to claim 1, the system for removing decay heat from the core of the reactor being a system for depressurisation of the steam present in the containment enclosure and the heat exchange device may be a water exchanger submerged in the pool or a direct intake of water from the pool on the one hand, and a containment wall condenser in direct contact with the steam present in the containment vessel of the reactor on the other hand.

6. The water nuclear reactor according to claim 1, the second reservoir of water being arranged in a part lower than the pool, advantageously on or in the ground.

7. The water nuclear reactor according to claim 1, the evaporator being submerged in or located remotely from the pool.

8. The water nuclear reactor according to claim 6, the submerged evaporator being a tubular exchanger.

9. The water nuclear reactor according to claim 6, the submerged evaporator being a plate exchanger.

10. The water nuclear reactor according to claim 1, further including comprising a cooling cycle including:
a compressor;
a condenser connected to the second pump to feed the latter with water;
an expansion member;
an air evaporator;
a fluidic circuit wherein a working fluid circulates in a closed loop, the fluidic circuit connecting the compressor to the condenser the condenser to the expansion member, the expansion member to the air evaporator, and the air evaporator to the compressor.

11. The water nuclear reactor according to claim 9, the cooling cycle condenser being the organic Rankine cycle condenser.

12. The water nuclear reactor according to claim 9, the working fluid of the cooling cycle being that of the organic Rankine cycle.

13. The water nuclear reactor according to claim 9, the shaft of the organic Rankine cycle expander being coupled to the shaft of the cooling cycle compressor.

14. The water nuclear reactor according to claim 1, the organic Rankine cycle machine and where applicable the cooling cycle being arranged in a lower part of the system, below the pool.

15. The water nuclear reactor according to claim 1, comprising an injector arranged in a lower part of the system and connected to the second pump arranged in a higher part of the system, the injector being adapted to prime the second pump.

16. The water nuclear reactor according to claim 1, comprising batteries for electrically starting the first pump, electric components of the organic Rankine cycle and where applicable of the cooling cycle, as well as the second pump.
